(19) United States
(12) Patent Application Publication
(10) Pub. No.: US 2005/0243803 A1
(43) Pub. Date: Nov. 3, 2005

(54) Dual-path data network connection method and devices utilizing the public switched telephone network

(76) Inventor: Xiaojun Fang, San Jose, CA (US)

Correspondence Address: XIAOJUN FANG, 1040 S. WINCHESTER BLVD. #15, San Jose, CA, 95128, US

(21) Appl. No.: 10/838,038

(22) Filed: May 3, 2004

(51) Int. Cl. H04L 12/28; H04L 12/66; H04L 12/56

(52) U.S. Cl. 370/352; 370/401

(57) ABSTRACT

This invention is a method and device for using one or a plurality of telephone network connections to pass call setup information to build secure Internet data connections between data network elements in different companies. A data network element 100 of present invention uses the public switched telephone network 180 to connect to other data network element 102 directly by dialing its phone number. The caller data network element and the callee data network element exchange identity and security management information through the PSTN connection 190/195. Secure data communication channels are established between the data network elements to tunnel through the public Internet 170 under the control of the PSTN connections.

### CROSS-REFERENCE TO RELATED APPLICATIONS

This application claims the benefit and is a continuation-in-part of U.S. patent application Ser. No. 60/450,535, filed on Feb. 22, 2003, and U.S.

### FIELD OF THE INVENTION

This invention relates generally to data networks, in particular to establishing secure data network connections automatically through the Internet. More specifically, it relates to the efficient method of establishing direct, highly secure communication connections over the public Internet by using the public switched telephone network (PSTN) for connection setup and security management.

### BACKGROUND AND SUMMARY OF THE INVENTION

Current enterprise Internet applications are mainly email, web browsing, and file transfer. Emerging multimedia applications utilize the broadband Internet infrastructure to support web-conferencing, video-conferencing, instant messenger, voice over Internet (VoIP), etc. Most enterprise data networks are behind a firewall for security protection, direct company to company data communication is not allowed. A service provider is required as the middleman to relay the traffic in order to solve the firewall traversal problem. Companies need to pay expensive monthly service fee. Furthermore, companies need to subscript service from the same service provider in order to communicate due to the fact that the application service providers are not interoperable.

Direct company-company multimedia communications over the Internet is the alternative way to save operation cost and solve the interoperability issue. Instead of subscripting services from a service provider, big corporations prefer to install their own application servers. If a company install the multimedia application server, it logically can be viewed as a “virtual service provider” (VSP) for its internal users. Direct company to company connection (VSP to VSP) cannot be realized today due to two main reasons: security concerns and lack of global directory for call connection. The security concerns include the lack of a trusted authentication method for external users, and lack of a method for encryption key authorization and exchange to create a secure tunnel for dynamic external users. The need for the global directory service comes from the fact that the Internet application uses the ‘presence-based” method for call connection. Users need to log into the same service provider's network to show their presence in the directory in order to connect. The need for a service provider is also for traffic relay for the firewall traversal and dynamic IP address resolution. Because a company cannot support inter-company directory, any inter-company IP call connection must go through a service provider even when there is no firewall traversal issue. Without the service provider, there is no way for a user to connect to another user behind a firewall.

The present invention is a method for establishing direct highly secure inter-company communication connections over the Internet. The public switched telephone network (PSTN) is utilized to create a second communication path between any two data network elements (DNE) through a telephone connection to exchange control and signaling information. The PSTN connection between any DNEs of different companies can be established by dialing the phone number, and data can be transported over the phone line using modem or other encoding techniques. The two peer DNEs connected by a PSTN connection will establish secure data connections over the Internet automatically by exchanging device and network information as well as security management information over the PSTN connection. This invention uses the dial-up PSTN connections to realize the global directory function because any DNEs with fixed telephone number can be reached by dialing that number. Direct, highly secure, business to business communications can be realized by this method without the need for a service provider.

### BRIEF DESCRIPTION OF THE FIGURES

FIG. 1 shows interfaces of a data network element of previous art.

FIG. 2 is network architecture for multimedia applications using the data network element of previous art;

FIG. 3 shows the interfaces of the data network element of the present invention;

FIG. 4 is the network architecture for multimedia applications using the present invention;

FIG. 5 shows general call connection setup process between two DNEs using the present invention;

FIG. 6 is the logic model for direct data communication network of the present invention;

FIG. 7a and FIG. 7b show the single-step security key authorization and exchange method and the double-step security key authorization and exchange method, respectively, for creating dynamic secure data tunnels between DNEs in different companies over the Internet.

FIG. 8 illustrates the connection method between two conference gateways by direct phone dialing.

### DETAILED DESCRIPTION

The present invention provides a method of creating direct company to company secure communication links over the Internet for multimedia applications. It uses the public switched telephone network (PSTN) as an overlay network to transmit signaling and control information between any data network elements (DNEs) of different companies. A DNE dials the phone number of the other DNE to connect the two DNEs with a PSTN line. Information exchange is conducted over the PSTN line to establish secure data connections through the Internet. There are two physical paths between any two DNEs of the present invention, an Internet path for mass data transport and a PSTN path for call setup and security management. The dual-path connection method supports two security key exchange schemes for data encryption.

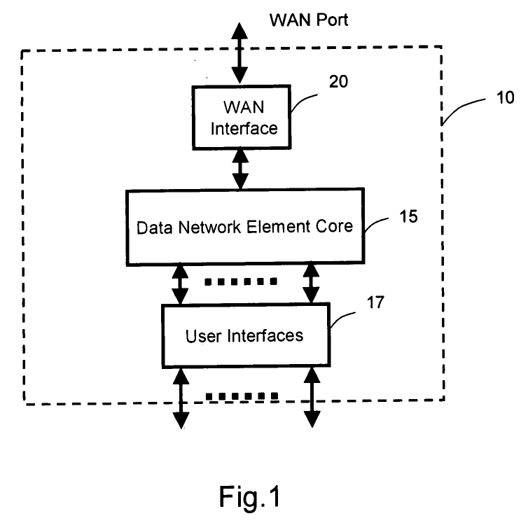

FIG. 1 shows network interfaces of a data network element (DNE) 10 of previous arts. It has only one network-side interface, the wide area network (WAN) interface 20. It has one or a plurality of user-side interfaces 17. Typical user-side interface includes interfaces to local area network (LAN), interfaces for personal computer (PC), interfaces for external servers, etc. End-system (ES) can be connected to the data network element through the user-interface 17 or LAN. The center of the DNE 10 is the data network element core 15. The term data network element is used here as the generic term to represent different types of data network element configurations, including but not limited to media gateway, multipoint control unit (MCU), application proxy/server, firewall, gatekeeper, network management system, etc., or any combination of the above modules.

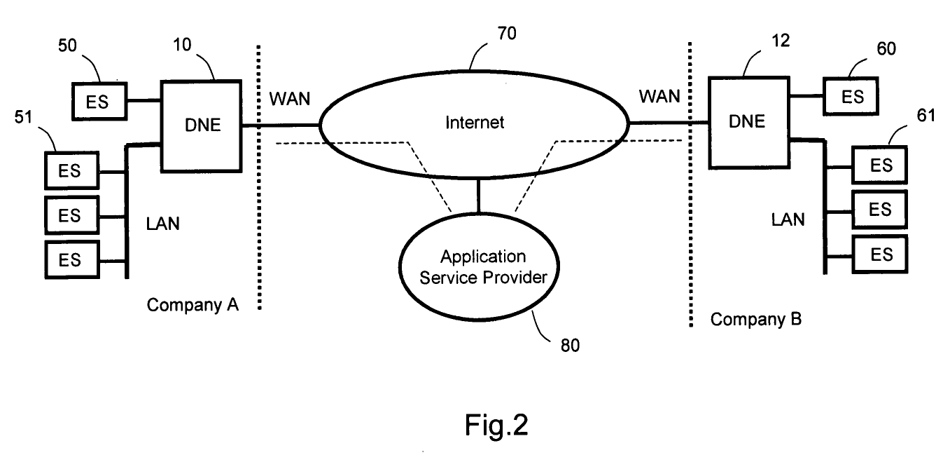

FIG. 2 shows the connection scheme of previous arts between DNE 10 in company A and DNE 12 in company B. The DNE in a company is located either on the LAN or in the demilitarized zone (DMZ). Typical installation of DNE is in the DMZ of a company's data network. Lower layer DNEs or end systems connect to other DNEs or end users through the DNE in the DMZ or in the service provider network for firewall traversal. The DNE 10 cannot directly connects to DNE 12 due to security concern and lack of global directory, even when both are in the DMZ. Instead, both the DNE 10 and the DNE 12 have to register in the same application service provider 80 to subscribe the service. Each DNE connects to the application service provider 80 through the Internet 70. The DNE in each company can be a company-owned equipment or a service provider-owned customer premises equipment (CPE). An end system (ES) within a company's LAN can either log directly into the application service provider's server to show its presence, or log into the local DNE inside the company to connect to the service provider through the DNE. Typical end systems in the multimedia application are PCs and videoconference equipment. Client software is typically required in the end system to support the multimedia application between the ES and the DNE. When the ES 51 logs in and shows its presence, any end systems already online can see the presence of the ES 51. For example, ES 60 in another company can request connection to ES 51 through the directory. The purpose of installing a DNE in a company rather than directly connecting all end systems to the service provider is for traffic monitoring and traffic aggregation and multicast to save WAN bandwidth. This traffic aggregation can have hierarchical layers for scalability.

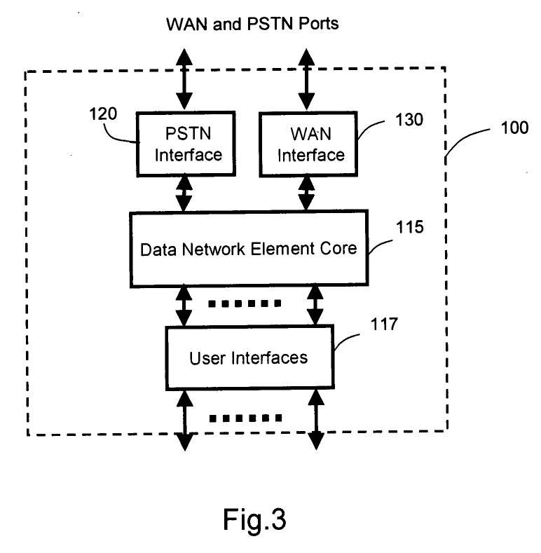

FIG. 3 shows architecture of the data network element 100 of present invention. The key difference from the previous arts is that the DNE 100 has two network-side interfaces, one is the WAN interface 130 for Internet connection, and the other is the PSTN interface 120 for telephone network connection. All other features are the same as that of the previous arts. The PSTN interface 120 is used to establish on-demand connectivity between any two DNEs in different companies by dialing the callee DNE's phone number. The PSTN interface 120 can be one or a plurality of analog phone lines, wireless phone lines, DS1 lines, or ISDN lines. Analog modem is the most convenient way to transport data over the PSTN with data rate up to 34 kbps. Other modulation schemes and physical media such as embedded tones, wireless network connection, etc., can also be employed for the PSTN interface.

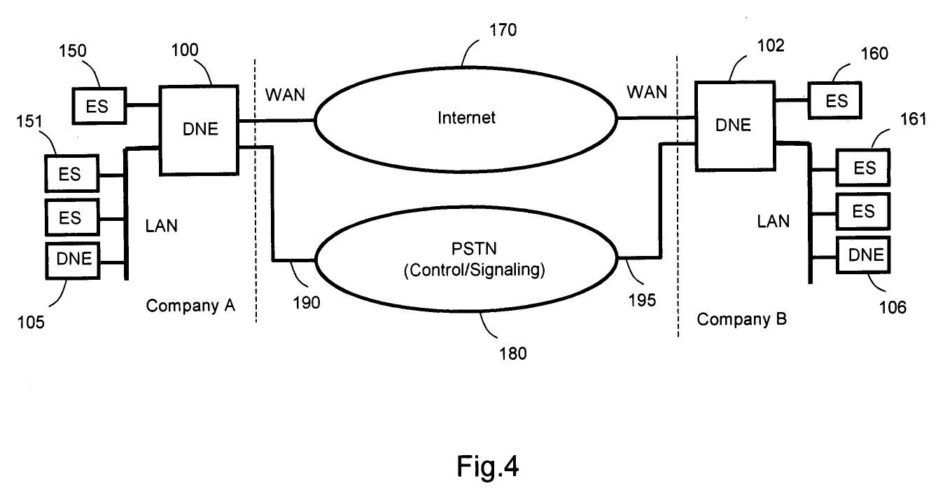

FIG. 4 shows network connection scheme of the present invention. Service provider is no long required in this architecture, and each company can be viewed as a virtual service provider (VSP). Inter-company communication is similar to service provider interoperability in this architecture. When DNE 100 in company A wants to connect to DNE 102 in company B, it first dial the phone number of the DNE 102 to establish a PSTN connection 190/195 through the PSTN network 180. Information exchange between the two DNEs will be performed over the PSTN connection. If the DNE 100 passes all security policies of the DNE 102, the DNE 102 will authenticate Internet data access to the DNE 100. Broadband Internet connections can be established between the DNE 100 and the DNE 102 through the Internet 170. After the secure Internet connections are established, the PSTN connection can be released and used for connecting to other DNEs for handshaking. The DNE based network can have hierarchical layers of DNEs for easy network management and bandwidth efficiency. FIG. 4 shows a lower layer DNE 105 is connected to the top layer DNE 100 through the LAN. The top layer DNE of a service domain can be in the company's headquarter or in the service provider network. Border gateway control protocol could be used in the top layer DNE to set policies for cross-domain connection management.

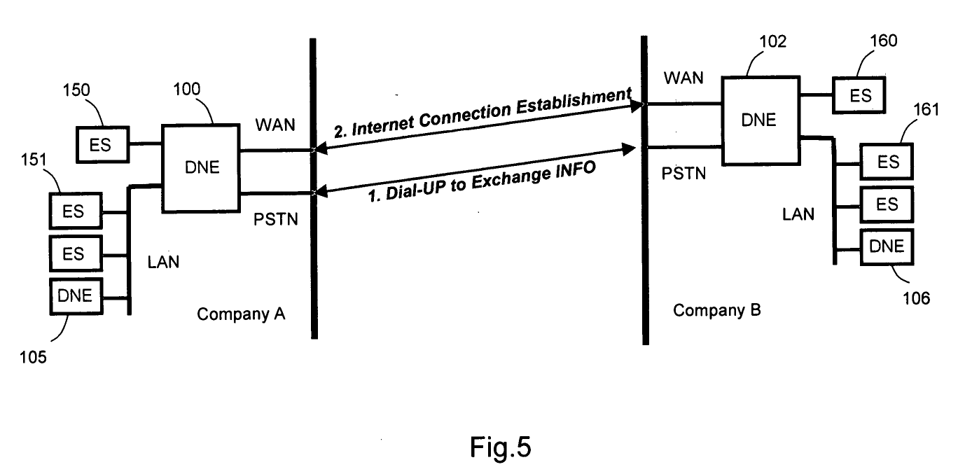

FIG. 5 illustrates the connection establishment process of the dual-path connection method. Both the DNE 100 and the DNE 102 are assumed located in the DMZ of the company's data network. When the ES 150 in company A wants to communicate with the ES 161 in company B, the DNE 100 in company A learns that the ES 161 is within the service domain covered by the DNE 102. This learning is done through the destination ES ID that contains information such as domain name or email address, etc., to reflect the association of the identity of its top layer DNE of the service domain. If the Internet data connection between the DNE 100 and the DNE 102 does not exist, the DNE 100 will use the telephone number of the DNE 102 to dial through the PSTN to connect. This telephone number can come from the DNE 100 database or from user input from the ES 150. The DNE 102 will automatically answer or deny the telephone call based on caller ID verification. If DNE 102 finds the caller ID belongs to a registered top layer DNE of a service domain, it will answer the phone ringing to establish the PSTN connection. The DNE 102 will check the identity information the DNE 100 sent, such as IP address or domain name, VSP ID and password, etc., to verify the identity of the caller DNE 100. The DNE 100 passes the identity verification, the DNE 102 will then send an <data access authentication> IP packet to the IP address of the DNE 100. The DNE 100 will reply this message with an <acknowledgement> message to the DNE 102 through the PSTN connection. The DNE 100 will then connect to DNE 102 through the Internet using the information and encryption method contained <data access authentication> message. After the data connections are established through the Internet, there are two communication paths between the DNE 100 and the DNE 102, an Internet path and a PSTN path. The PSTN path can be released after the secure Internet data connections have been established successfully, or remained active to transport dynamic security information between the two DNEs. An end system in company A can connect to an end system in company B through the DNE 100 and the DNE 102. An end system can accept or deny a call request from another end system. If the end system accept the call, end-end application connection between the two end systems will be established.

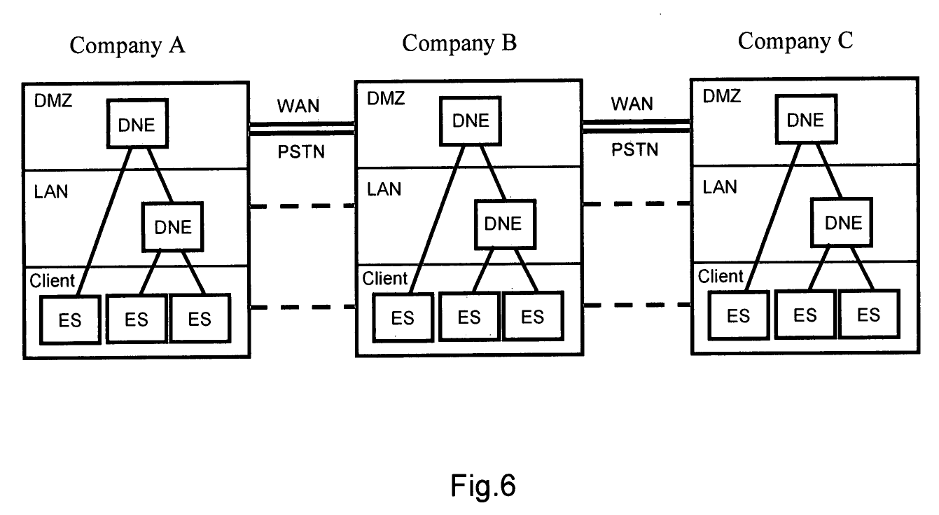

Each DNE can connect to a plurality of DNEs in different companies concurrently to support multiple-party conferences. A company's multimedia network can be hierarchical with multiple layers of DNE according the user number and user distribution. Inter-company or inter-domain connections are always through the top layer DNEs. This network architecture is shown in FIG. 6, where inter-company connection is through the top layer DNE sit in the DMZ of the company's data network or a service provider network. The top layer DNE can also accept direct access request from authorized external ES/users, just like a service provider. Physical connections between DNEs of different companies are not permanent. They can be removed after a provisionable period of time.

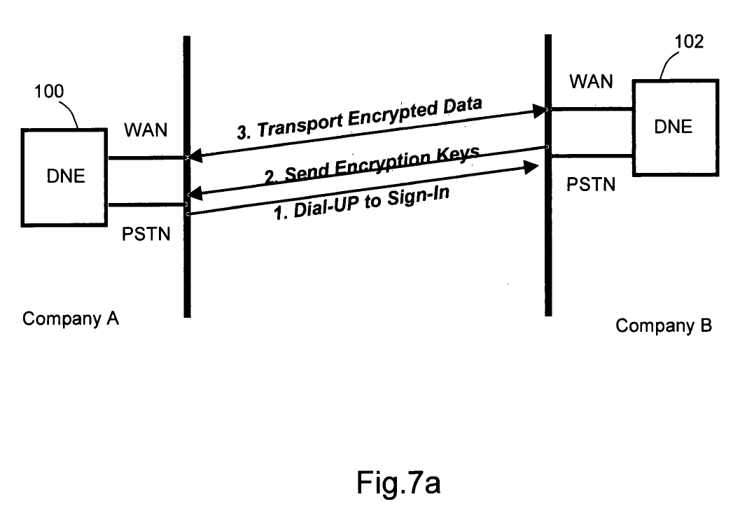

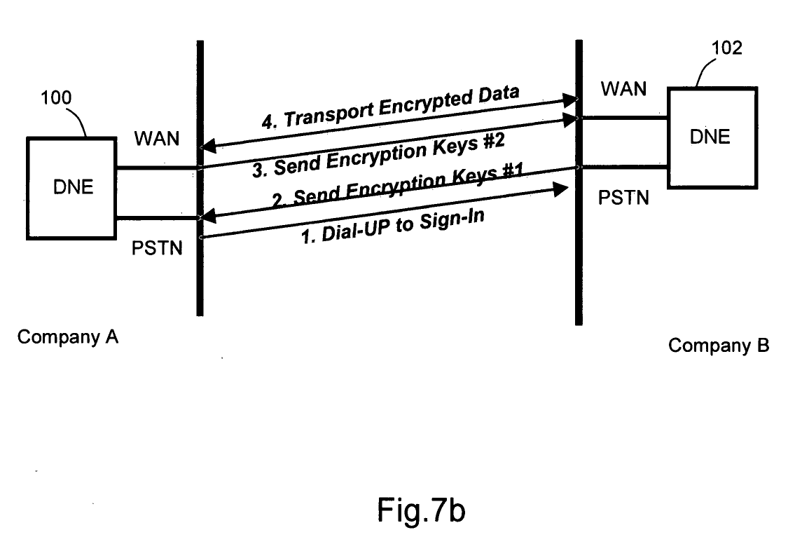

Data encryption is used as the way to establish secure data tunnels through the Internet. Current encryption and decryption method uses static security keys. The dual-path connection method of present invention uses the PSTN connections and the combination of the PSTN connections and the Internet connections for authorizing and dynamically exchanging encryption keys to enhance the transmission security. This scheme applies not only to the company to company secure connections, but also to the virtual private network (VPN) between branch offices of the same company. FIG. 7 shows two dynamic encryption key exchange schemes.

FIG. 7a shows the single-step encryption key exchange scheme. When the caller DNE 100 in company A want to connect to the callee DNE 102 in company B though a secure IP connection, it will call the callee DNE 102 through the telephone line first. After the callee DNE 102 finishes the caller identity verification, it will send access authentication and encryption keys to the caller DNE 100. The DNE 100 uses the encryption keys to encrypt its data and logs into the DNE 102 through the Internet. After the DNE 100 has logged into the DNE 102, a secure Internet data tunnel between the DNE 100 and the DNE 102 is established for data transmission.

FIG. 7b shows the double-step encryption key exchange scheme. After the DNE 102 completed the identity verification, the callee DNE 102 will send encryption key #1 with its log in method. The DNE 100 uses the encryption key #1 to encrypt its data and log into the DNE 102. Upon successfully logging in, the DNE 100 will send encryption key #2 to the DNE 102 with encryption. Both key #1 and key #2 will be used for data encryption between the two DNEs. This process can be on-going all the time to build a data tunnel with dynamic keys that are exchanged through two different physical paths. Because the encryption information is exchanged in two different physical paths in a coherent way, it is almost impossible to decrypt the data for a hacker. The double-step encryption key exchange scheme also applies when two telephone lines are used. Multiple-step encryption key exchange can be realized by using multiple phone lines and the Internet connection.

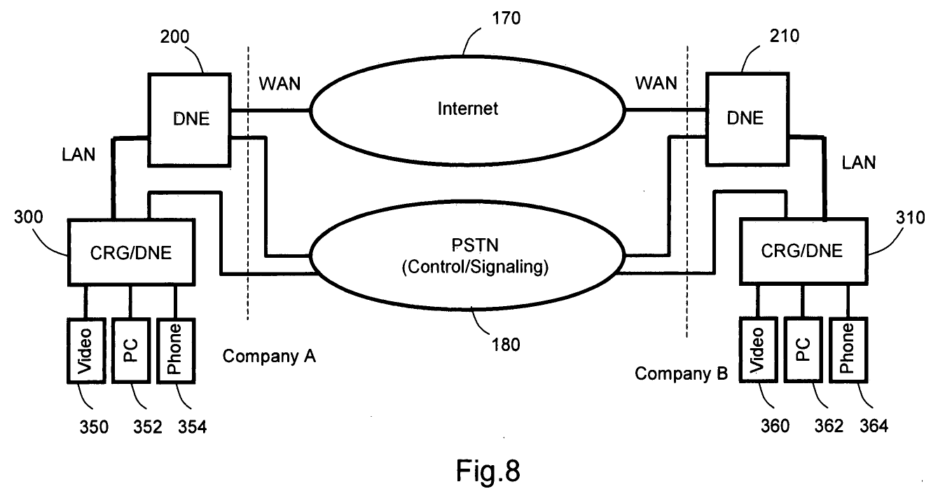

FIG. 8 shows a configuration of the low layer DNE for conference room applications. The device of this configuration is called conference room gateway (CRG) 300/310, which is a DNE configuration for particular application. The CRG 300 is located in a conference room, and it interfaces directly with common conference room meeting equipment such as videoconference equipment 350, computer 352, and conference telephone 354. An embedded data channel is used for data transmission in the analog telephone line between the CRG 300 and the CRG 310 for device handshaking and firewall traversal. The conference room telephone can be an analog phone, a digital phone, or an IP phone. Since the telephone in a conference room always has a fixed telephone number associated with it, the CGR 300 can connect its PSTN path to the CRG 310 by dialing the phone number of the conference room telephone that associated with the CRG 310. A PSTN connection for data and voice transmission can be established between the two CGRs in this way. Similar to the generic dual-path IP connection establishment method discussed previously, the two CRGs can build secure Internet data connections through the top layer DNE 200 and the DNE 210, or one of them. Only two CRGs are shown in FIG. 8 for simplicity, multiple CRGs can be connected together through the Internet for multi-party conference. Because all CRGs are connected together by secure data tunnels, it logically forms a virtual LAN for the end systems attached. The attached end systems, such as computers and videoconferencing equipment, are virtually in the same LAN through header translation and encapsulation performed by each CRG. The DNE 200 and/or DNE 210 may support multipoint control unit (MCU) functions to enable multiple-party video/audio conference.

If the telephone interface of the CRG is an analog phone line, it has codec to convert analog voice to digital signal with echo cancellation. The CRG can optionally convert the voice signal into voice over IP (VoIP) packets and send them to other CGRs through the Internet. The received voice signals from the Internet and the PSTN line will be mixed at the speaker, and the voice signal from the telephone microphone will be multicasted to both the Internet and the PSTN line. The CRG performs the gateway function for the two voice networks.

The invention has been described with respect to particular embodiments thereof, it is understood that numerous modifications can be made without departing from the spirit and scope of the invention as set forth in the claims.

1. A method and devices of using the telephone network for Internet connection set up and security management between data network elements, comprising
(a) a wide area network interface for connecting to one or a plurality of data network elements over the Internet, and
(b) a public switched telephone network interface for connecting to one or a plurality of data network elements over the public switched telephone network, and
(c) one or a plurality of user interfaces for end system access, and
(d) a data network element core, and
(e) one or a plurality of telephone network connections between any two data network elements for Internet connection setup and security management, and
(f) one or a plurality of broadband Internet data connections between any two data network elements for application data transport.

2. The method of claim 1, wherein the said public switched telephone interface is one or a plurality of analog telephone lines, wireless phone lines, DS1 lines, or ISDN lines.

3. The method of claim 1, wherein the said user interface is a local area network interface, a videoconference equipment interface, a computer interface, or a telephone interface.

4. The method of claim 1, wherein the said data network element is a media gateway, .a multipoint switch unit, a conference room gateway, an application proxy/server, a gatekeeper, a firewall, a management system, or any combination of them.

5. The method of claim 1, wherein the said two data network elements are a caller data network element that initiates the request for Internet data connections, and a callee data network element that accepts or rejects the connection request.

6. The method of claim 1, wherein the said public switched telephone network interface has assigned phone number/numbers and caller ID service for the said data network element to connect to other said data network elements through the said telephone network.

7. The method of claim 1, wherein the said telephone connection is established by automatic or manual phone number dialing.

8. The method of claim 1, wherein the said telephone connection is used to pass initial connection setup and security management information between the said data network elements to set up the said Internet data connections.

9. The method of claim 5, wherein the said callee data network element monitors caller ID of the incoming call on the said public switched telephone network interface to decide whether to answer or to deny the call.

10. The method of claim 5, the said callee data network element verifies the identity information of the said caller data network element, and authenticates the said caller data network element data network for access through the Internet.

11. The method of claim 5, wherein the said data network elements generate and exchange encryption keys over the said telephone connections or the combination of the said telephone connections and the said Internet data connections to establish encrypted data tunnels over the Internet.

12. The method of claim 4, wherein the said conference room gateway is dual-path data network element for conference applications, and its user interfaces connect to a videoconference equipment, a computer for data conferencing, and a telephone for audio conferencing.

13. The method of claim 12, wherein the said conference room gateways are connected together through the Internet data connections to form a virtual local area network for the attached videoconferencing equipment and computers.
